(19) United States
(12) Patent Application Publication
(10) Pub. No.: US 2026/0037449 A1
(43) Pub. Date: Feb. 5, 2026

(54) DATA STORAGE DEVICE TO EFFICIENTLY MANAGE MAP DATA AND METHOD OF OPERATING THE SAME

(71) Applicant: SK hynix Inc., Gyeonggi-do (KR)

(72) Inventors: Hee Chan SHIN, Gyeonggi-do (KR); Jeong Sun PARK, Gyeonggi-do (KR); Woong Sik SHIN, Gyeonggi-do (KR); Young Ho AHN, Gyeonggi-do (KR); Hye Rim YOO, Gyeonggi-do (KR); Min Woo LIM, Gyeonggi-do (KR)

(21) Appl. No.: 19/046,543

(22) Filed: Feb. 6, 2025

(30) Foreign Application Priority Data
Jul. 30, 2024 (KR) 10-2024-0101189
Oct. 2, 2024 (KR) 10-2024-0134011

(51) Int. Cl. G06F 12/10

(52) U.S. Cl. CPC G06F 12/10

(57) ABSTRACT

A data storage device may include a memory device and a memory controller. The memory controller is configured to extract a key value from a modified logic address, and map, to a physical address of the memory device, an index generated based on the modified logic address and the key value.

### CROSS-REFERENCES TO RELATED APPLICATION

The present application claims priority under 35 U.S.C. § 119 (a) to Korean application number 10-2024-0101189, filed on Jul. 30, 2024, and Korean application number 10-2024-0134011, filed on Oct. 2, 2024, which are incorporated herein by reference in their entirety.

### BACKGROUND

### 1. Technical Field

Embodiments of the present disclosure relate to a data storage device, and more specifically, relate to a data storage device to efficiently manage map data and a method of operating the same.

### 2. Related Art

A data storage device may store data in the memory device or may read data stored in the memory device according to a request of an external device.

An address (i.e., logic address) processed by the external device may be different from an address (i.e., physical address) for indicating a position to be written or to read data in the memory device. Therefore, the data storage device may perform address translation (i.e., address mapping) between the address processed by the external device and the address for the memory device.

### SUMMARY

Embodiments of the present disclosure may provide a data storage device capable of efficiently managing map data to provide consistent write performance regardless of workload types.

Embodiments of the present disclosure also provide a method of operating the data storage device.

According to embodiments of the present disclosure, there may be provided a data storage device. The data storage device may include a memory device and a memory controller. The memory controller may extract a key value from a modified logic address generated by at least modification of a source logic address externally provided, and map, to a physical address of the memory device, an index generated based on the modified logic address and the key value.

According to embodiments of the present disclosure, there may be provided a method of operating a data storage device including a memory device and a memory controller. The method of operating the data storage device may include generating, by the memory controller, a modified logic address based on a source logic address externally provided; extracting, by the memory controller, a key value based on the modified logic address; generating, by the memory controller, an index based on the modified logic address and the key value; and mapping, by the memory controller, the index to a physical address of the memory device.

According to embodiments of the present disclosure, there may be provided a data storage device. The data storage device may include a memory device and a memory controller configured to control the memory device. The memory controller may include a mapping manager and a processor. The mapping manager is configured to generate an index based on a key value and a modified logic address, and generate mapping information by mapping the index and a physical address of the memory device, the key value being generated by extracting from the modified logic address generated by converting a source logic address externally provided at least once. The processor may control the memory device to program write data into a position of the memory device, corresponding to the mapping information in response to a write request externally provided. The key value extracted from specified bit digit values of the modified logic address, is generated with a random distribution, and the write data is distributed and stored in the memory device based on the key value with the random distribution.

According to embodiments of the present disclosure, there may be provided a data storage device. The data storage device may include a memory device and a memory controller. The memory controller may generate a physical address corresponding to a source logic address based on a key value extracted from a modified logic address generated from the source logic address included in a write request in response to the write request externally provided. The memory controller receives a stride patterned access request in which a difference between the source logic addresses included in continuously provided write requests is uniform, the key values extracted from the source logic addresses are identical, and the key values extracted from modified logic addresses generated based on the source logic addresses are different.

According to embodiments of the present disclosure, a performance of the data storage device can be improved by processing mapping information of the address according to a write request at high speed.

### BRIEF DESCRIPTION OF THE DRAWINGS

The above and another aspects, features and advantages of the subject matter of the embodiments of the present disclosure will be more easily understood from the following detailed description taken in conjunction with the accompanying drawings, in which:

FIG. 1 is a block diagram illustrating a data processing system based on an embodiment of the present disclosure;

FIG. 2 is a block diagram illustrating a memory controller based on an embodiment of the present disclosure;

FIG. 3 is a block diagram illustrating a mapping manager based on an embodiment of the present disclosure;

FIG. 4 is a conceptual diagram illustrating an operation of a mapping manager based on an embodiment of the present disclosure;

FIG. 5 is a view illustrating concepts for extracting an address modulation and key value based on an embodiment of the present disclosure;

FIG. 6 is a flowchart illustrating a method of operating a data storage device based on an embodiment of the present disclosure;

FIG. 7 is a block diagram illustrating a mapping manager based on an embodiment of the present disclosure;

FIG. 8 is a flowchart illustrating a method of operating a data storage device based on an embodiment of the present disclosure;

FIGS. 9A and 9B are views illustrating a throughput and a performance consistency based on address mapping schemes;

FIG. 10A and FIG. 10B are views illustrating a difference in throughput based on the address mapping scheme; and

FIGS. 11a and 11B are views illustrating a difference in throughput based on workload and address mapping scheme.

### DETAILED DESCRIPTION

Embodiments of the present disclosure will now be described in more detail with reference to the accompanying drawings.

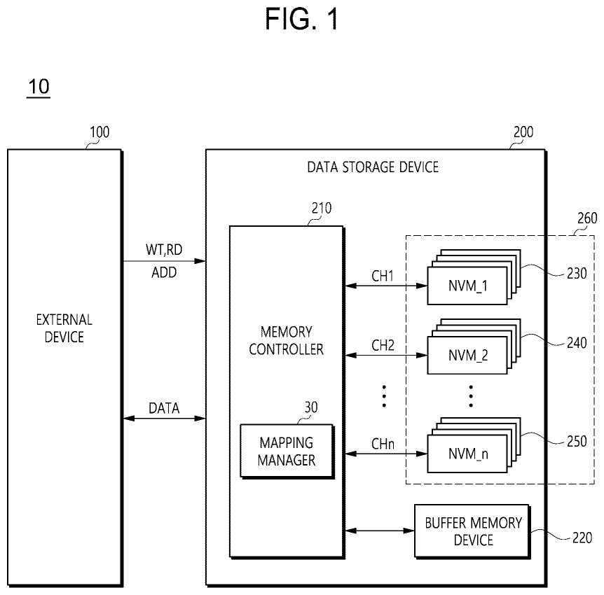

FIG. 1 is a block diagram illustrating a data processing system 10 based on an embodiment of the present disclosure.

Referring to FIG. 1, the data processing system 10 may include an external device 100 and a data storage device 200.

The external device 100 may include at least one processor. The external device 100 may be a processor itself, or an electronic device or system including a processor. The external device 100 may function as a host device for the data storage device 200.

The data storage device 200 may include a memory controller 210, a buffer memory device 220 and a storage medium 260. The storage medium 260 may include at least a plurality of non-volatile memory devices (NVM1, NVM2, . . . , NVMn; 230, 240 and 250). The buffer memory device 220 may be optionally provided in the data storage device 200, i.e., the data storage device 200 may be provided with or without the buffer memory device 220.

The external device 100 may transmit a write request including a write command WT, an address ADD and write data DATA to the data storage device 200 to write the data. The data storage device 200 may operate to program the write data into the storage medium 260 based on the write request.

The external device 100 may transmit a read request including a read command RD and an address ADD to the data storage device 200 to read the data. The data storage device 200 may read the read-requested data DATA from the storage medium 260 and transmit the read-requested data DATA to the external device 100.

In addition to the read and write requests from the external device 100, the data storage device 200 may internally generate the read request or the write request to read or write data from the storage medium 260 to perform an internal management operation to manage the storage medium 260. The internal management operation may include a housekeeping action which is performed independent of requests from the external device 100, such as a wear-leveling, a garbage collection, and a read reclaim, to efficiently use a storage space on the storage medium 260 or to ensure reliability of data stored on the storage medium 260.

The storage medium 260 may be coupled to the memory controller 210 via at least one channel (CH1, CH2, . . . , CHn). In an embodiment, the non-volatile memory devices 230, 240 and 250 may be at least one of a NAND flash memory device, a NOR flash memory device, a ferroelectric RAM (FeRAM) using a ferroelectric capacitor, a magnetic RAM (MRAM) using a tunneling magneto-resistive (TMR) layer, a chalcogenide compound (CHC), a phase change memory device (PCRAM) using chalcogenide alloys, a resistive memory device (ReRAM) using a transition metal oxide, and the like.

Each of the non-volatile memory devices 230, 240 and 250 may include a plurality of memory cells. Each of the memory cells may operate as a single level cell (SLC) capable of storing one bit of data, or as a multi-level cell (MLC) capable of storing two or more bits of data. At least one of the non-volatile memory devices 230, 240 and 250 may operate as a memory device including the single level cell (SLC). At least one of the non-volatile memory devices 230, 240 and 250 may operate as a memory device including a multi-level cell (MLC). Some memory cells of each of the nonvolatile memory devices 230, 240 and 250 may operate as single-level cells (SLC) and some may operate as multi-level cells (MLC).

The buffer memory device 220 may temporarily store data or

map data transmitted or received between the external device 100 and the data storage device 200 during write or read operations. The map data may be a set of mapping information between addresses (i.e., physical addresses) of the physical storage space including the storage medium 260 and a logic address assigned to the storage medium 260 by the external device 100.

The mapping information may be a map entry that points to a physical address specified in a unit logic address, and map data may be a set of the map entry.

The map data may be stored on the storage medium 260, and the memory controller 210 may load the map data required for operation of the data storage device 200 at least partially into the buffer memory device 220 or the internal memory (not shown) of the memory controller 210 for use.

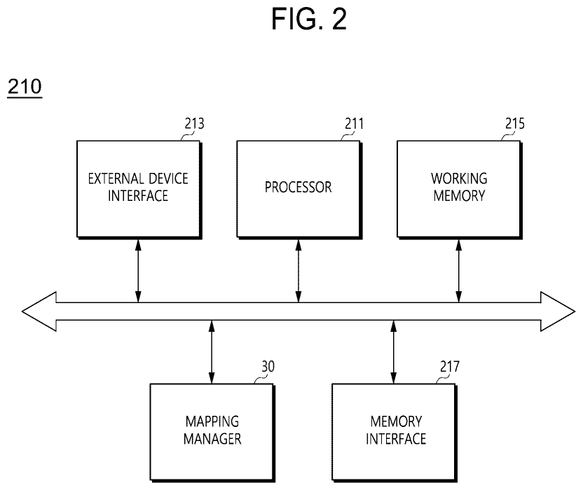

FIG. 2 is a block diagram illustrating a memory controller based on an embodiment of the present disclosure.

Referring to FIG. 2, the memory controller 210 may include a processor 211, an external device interface 213, a working memory 215, a memory interface 217 and a mapping manager 30.

The processor 211 may operate a firmware or a software provided on a hardware for various operations of the memory controller 210. The processor 211 may include a combination of the hardware and the firmware or the software operating on the hardware. In an embodiment, the processor 211 may perform a function of a flash translation layer (FTL) for managing the data storage device 200.

The external device interface 213 may provide a communication channel for receiving commands and a clock signal from the external device 100 and controlling an input and output of data under the control of the processor 211. In particular, the external device interface 213 may provide a physical connection between the external device 100 and the data storage device 200.

In an embodiment, the external device interface 213 may comply with a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA (SATA) protocol, a parallel-ATA (PATA) protocol, a small computer small interface (SCSI) protocol, ESDI (enhanced small disk interface) protocol, IDE (Integrated Drive Electronics) protocol, private protocol, SMBus (System Management Bus) protocol, I2C (Inter-Integrated Circuit) protocol, 13C (Improved Inter-Integrated Circuit) protocol, and the like, and may communicate with the external device 100 based on an interface using at least one of the various interface protocols.

The external device interface 213 may store write data provided from the external device 100 in the buffer memory device 220 under control of the processor 211. Data read from the storage medium 260 and stored in the buffer memory device 220 may be provided to the external device 100. If the data storage device 200 does not include the buffer memory device 220, the write data and read data may be transmitted and received via the operation memory 215.

The working memory 215 may be configured as a random access memory device, such as dynamic random access memory (DRAM) or static random access memory (SRAM). The working memory 215 may store firmware performed by the processor 211. In addition, the working memory 215 may store data necessary to drive the firmware, such as metadata. The metadata may include system information or attributes corresponding to the memory block. The metadata may be stored in specific pages of the memory block, and the processor 211 may load the metadata into the working memory 215 as needed for operation of the data storage device 200.

In addition, the working memory 215 may serve as a buffer memory for storing write data provided by the external device 100 and read data read from the storage medium 260.

The metadata may include map data. The map data loaded into the working memory 215 or buffer memory device 220 may be referred to as a map table.

The memory interface 217 may provide a communication channel for transmitting and receiving signals between the memory controller 210 and the storage medium 260. The memory interface 217 may transmit data temporarily stored in the buffer memory device 220 to the storage medium 260 under the control of the processor 211. The memory interface 217 may transmit read data from the storage medium 260 to the buffer memory device 220 for temporary storage based on the control of the processor 211.

The mapping manager 30 may convert a logic address provided from the external device 100 into a physical address based on at least one of the read and write requests.

As the external device 100 may transmit a write logic address with the write request, the mapping manager 30 may convert or refine the write logic address to generate a modified write logic address. The mapping manager 30 may select at least a portion of the modified logic address as a key value. The mapping manager 30 may generate an index including a fixed length by operating on the modified write logic address and the key value using a set function. Further, the mapping manager 30 may specify a physical address corresponding to the index, and may generate mapping information by mapping the index to the physical address. The mapping information may be stored in a map table loaded into the working memory 215 or the buffer memory device 220. As the mapping information may be generated by the mapping manager 30, the processor 211 may control the storage medium 260 to program the write data based on the mapping information.

When the mapping information corresponding to the write logic address provided from the external device 100 may already exist, the mapping manager 30 may generate new mapping information by specifying a new physical address and invalidate the old mapping data, but the embodiments are not limited to.

When the external device 100 transmits the read logic address with the read request, the mapping manager 30 may generate an index for the read logic address in the same manner as for processing the write request. The mapping manager 30 may search mapping information corresponding to the index from the map table. The processor 211 may control the storage medium 260 to read data according to the physical addresses included in the searched mapping information.

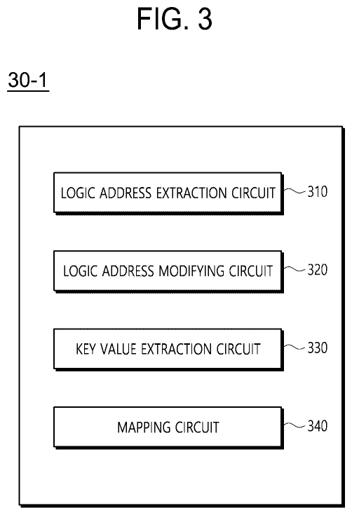

FIG. 3 is a block diagram illustrating a mapping manager 30-1 based on an embodiment of the present disclosure.

Referring to FIG. 3, the mapping manager 30-1 may include a logic address extraction circuit 310, a logic address modifying circuit 320, a key value extraction circuit 330 and a mapping circuit 340. The logic address extraction circuit 310 may extract a source

logic address corresponding to a logic address, from the request of the external device 100, as the external device 100 requests an access to the data storage device 200.

The logic address modifying circuit 320 may convert or modify the source logic address to generate a modified logic address. In an embodiment, the logic address modifying circuit 320 may shift at least one bit of the source logic address. For example, the logic address modifying circuit 320 may convert a logic address by shifting the source logic address at least once by the specified number of bits to the left or right. The converted logic address may be outputted as a modified logic address.

In an embodiment, the logic address modifying circuit 320 may combine the converted logic address with the source logic address to generate the modified logic address. For example, the logic address modifying circuit 320 may combine the converted logic address with the source logic address based on at least one of an arithmetic sum, a logic summation and a logic multiplication.

The key value extraction circuit 330 may extract at least a portion of the modified logic address as a key value. In an embodiment, the key value extraction circuit 330 may extract a plurality of specified bit digit values from the modified logic address as the key value.

The mapping circuit 340 may operate on the modified logic address and the key value using a set function, to generate an index including the fixed length. In an embodiment, the mapping circuit 340 may generate a hash value by operating on the modified logic address and the key value using a set hash function and determine an index based on the hash value, but the embodiments are not limited to. That is, the mapping circuit 340 may generate the index using a variety of mapping functions that may operate on input data with arbitrary length and convert it to data with the fixed length.

The mapping circuit 340 may specify a physical address corresponding to the determined index, and may generate mapping information by mapping the logic address to the physical address. The mapping information may be stored in a map table loaded into the working memory 215 or the buffer memory device 220. As the mapping information is generated by the mapping manager 30, the processor 211 may control the storage medium 260 to process a request from the external device 100 based on the mapping information.

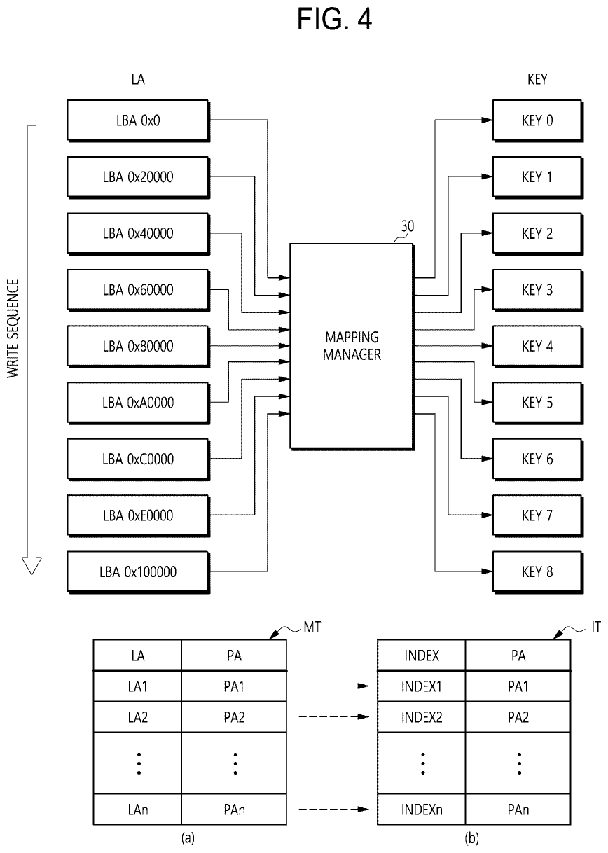

FIG. 4 is a conceptual diagram illustrating an operation of the mapping manager 30 based on an embodiment of the present disclosure.

Referring to FIG. 4, the mapping manager 30 may extract a key value KEY (e.g., KEY 0 to KEY 8) from a modified logic address that modifies a source logic address LA (e.g., LBA 0x0 to LBA 0x100000) provided from an external device.

The mapping manager 30 may perform a function that takes as input the modified logic address and a key value to generate an INDEX with a fixed length.

The mapping manager 30 may generate an index table IT, which is a mapping table between the index INDEX and a physical address PA, by specifying the physical address PA corresponding to the generated index INDEX.

The mapping manager 30 may manage the source logic address LA and the physical address PA mapped to them, as indicated by the index INDEX, in a mapping table MT.

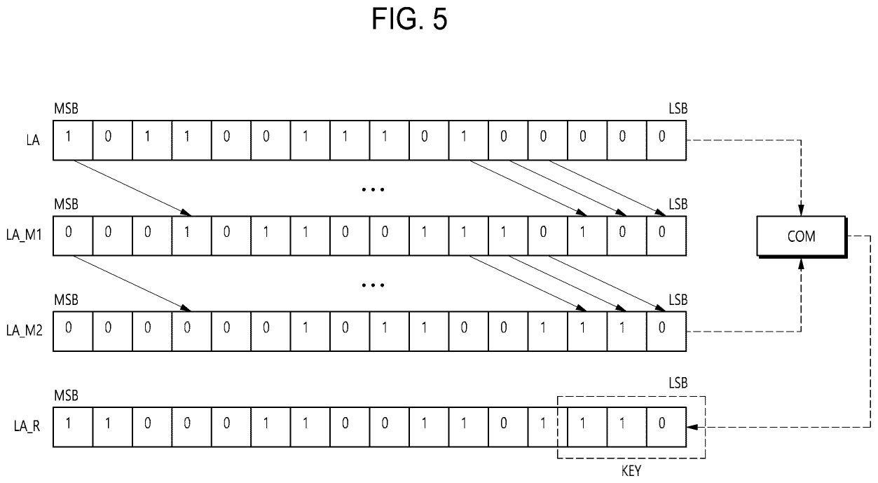

FIG. 5 is a diagram illustrating concepts of extractions of a modified address and a key value based on an embodiment of the present disclosure.

Referring to FIG. 5, the mapping manager 30 may extract a source logic address LA coupled with the request from the external device 100. In FIG. 5, an LSB indicates the least significant bit and an MSB indicates the most significant bit.

The mapping manager 30 may convert the source logic address LA at least once to generate a modified logic address LA_M1, LA_M2. In an embodiment, the mapping manager 30 may generate the modified logic address LA_M1, LA_M by shifting the source logic address LA at least once by a specified number of bits to the left or right.

For example, the source logic address LA is shifted 3 bits to the left to generate a first converted logic address LA_M1. The first converted logic address LA_M1 is shifted 3 bits to the left to generate a second converted logic address LA_M2.

The mapping manager 30 may combine (COM) second converted logic address LA_M2, which is a finally converted logic address, with the source logic address LA, to generate a modified logic address LA_R. In an embodiment, the mapping manager 30 may arithmetically sum the converted logic address with the source logic address to generate the modified logic address LA_R.

The mapping manager 30 may extract at least a portion of the modified logic address LA_R as a key value KEY. In an embodiment, the mapping manager 30 may extract 3 bits from the least significant bit LSB of the modified logic address LA_R as the key value KEY.

Generating the modified logic address might not be limited to the embodiment shown in FIG. 5. For example, the mapping manager 30 may determine the first converted logic address LA_M1 as the modified logic address. Alternately, the mapping manager 30 may determine the second converted logic address LA_M2 as the modified logic address. The mapping manager 30 may generate the modified logic address by converting the source logic address LA at least once.

Since the physical address is mapped to the modified logic address generated by converting the source logic address through a mapping function, the modified logic address may be evenly distributed within a range of the mapping table, a concentrative access to specific memory regions is prevented.

In particular, an embodiment of the present disclosure generates the mapping information based on the key value from the modified logic address by the external device 100.

For example, when the mapping information is generated by extracting a key value from a set bit position of the logic address, the set bit position may conflict with an index generated from the same logic address. According to an embodiment of the present disclosure, since the index is generated using the key value extracted from the modified logic address, the key value may have a random distribution, thus avoiding conflicts between the indexes.

Since the logic address is converted at least once, the key value to be used to generate the physical address may be distributed. As a result, data may be distributed and stored in the memory regions corresponding to the physical address generated based on the distributed key value, and mapping information may be retrieved at a high speed.

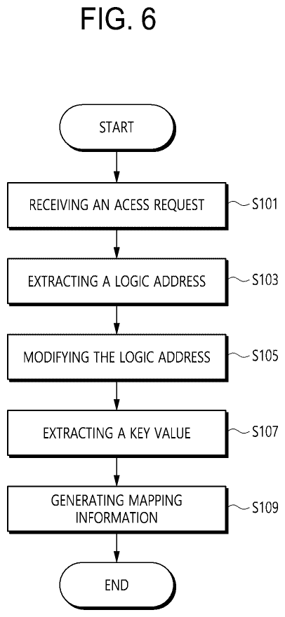

FIG. 6 is a flowchart illustrating a method of operating a data storage device based on an embodiment of the present disclosure.

Referring to FIG. 6, as an external device (i.e., 100 of FIG. 1) may request access to a data storage device (i.e., 200 of FIG. 1) (at operation S101), a memory controller (i.e., 210 of FIG. 1) may extract a source logic address, which is a logic address provided by the external device 100 (at operation S103).

The memory controller 210 may generate a modified logic address by converting the source logic address at least once (at operation S105). In an embodiment, the memory controller 210 may generate a converted logic address by shifting the source logic address at least once by a number of bits set to the left or right, as the modified logic address. In an embodiment, the memory controller 210 may combine the converted logic address with the source logic address to generate the modified logic address. For example, the memory controller 210 may combine the converted logic address with the source logic address by at least one of an arithmetic summation, a logic summation, a logic multiplication, or the like.

The memory controller 210 may extract at least a portion of the modified logic address, such as a plurality of specified bit digit values, as a key value (at operation S107). In an embodiment, the memory controller 210 may extract a set N, where N is a natural number, of bits from the least significant bit LSB of the modification logic address as the key value KEY.

The memory controller 210 may set a physical address to an index including a fixed length generated by operating the modified logic address and the key value as a set function, and generate mapping information by mapping the logic address related to the index and the physical address (at operation S109).

In an embodiment, the memory controller 210 may generate a hash value by operating the modified logic address and the key value using a set hash function and determine an index based on the hash value, but is the embodiments are not limited to.

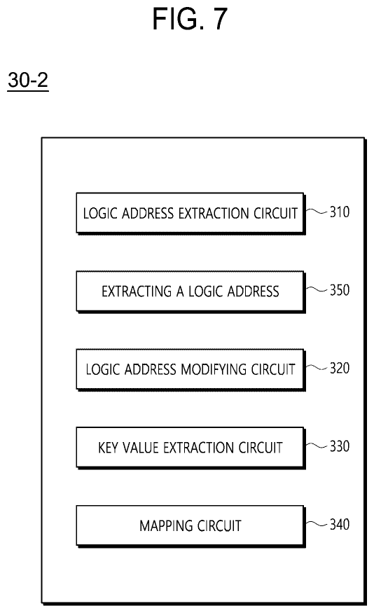

FIG. 7 is a block diagram illustrating a mapping manager 30-2 based on an embodiment of the present disclosure.

Referring to FIG. 7, the mapping manager 30-2 may include a logic address extraction circuit 310, a logic address modifying circuit 320, a key value extraction circuit 330, a mapping circuit 340 and workload determination circuit 350. Since configurations of the logic address extraction circuit 310, the logic address modifying circuit 320, the key value extraction circuit 330 and the mapping circuit 340A are the same as those of FIG. 3, duplicate description is omitted.

The workload determination circuit 350 may determine a pattern of a logic address included in an access request from the external device 100.

In an embodiment, the workload determination circuit 350 may determine if the logic addresses are provided in a stride pattern.

The stride pattern refers to the aspect in which the logic address for which access is requested is shifted by a certain value from the logic address included in the previous access request. From another perspective, the stride pattern refers to a write pattern in which the difference between adjacent logic addresses within a continuous sequence of the same type requests is constant.

Referring to FIG. 4, when a difference between adjacent logic addresses LAs within a sequence of consecutive write requests “Write Sequence” is constant as ‘20000,’ the workload determination circuit 350 may determine a workload of the stride pattern.

When the mapping manager 30-2 receives an access request of the stride pattern, the mapping manager 30-2 may refine (or convert) the logic address provided by the external device 100 to extract a key value, generate an index, and map the index to a physical address.

When the mapping manager 30-2 receives an access request without the stride pattern, the mapping manager 30-2 may extract the key value from the logic address provided by the external device 100, generate the index, and map the index to the physical address.

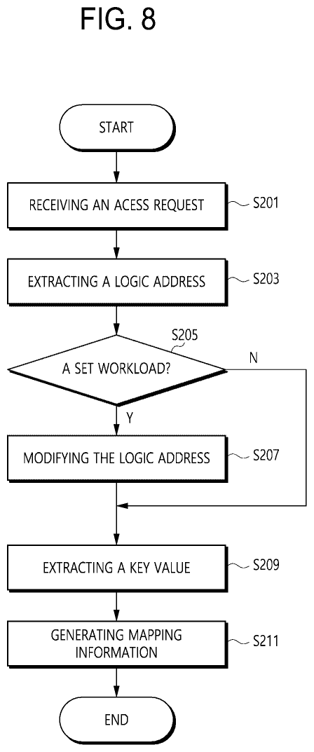

FIG. 8 is a flowchart illustrating a method of operating a data storage device based on an embodiment of the present disclosure.

Referring to FIG. 8, as an external device (i.e., 100 of FIG. 1) may request access to a data storage device (i.e., 200 of FIG. 1) (at operation S201), a memory controller (i.e., 210 of FIG. 1) may extract a source logic address, which is a logic address provided by the external device 100 (at operation S203).

The memory controller 210 may determine whether the request from the external device 100 is a set workload, such as, a workload with the stride pattern, based on a pattern of an extracted logic address (at operation S205).

If the request is the set workload (i.e., ‘Y’ in operation S205), the memory controller 210 may generate a modified logic address, by converting the source logic address at least once (at operation S207). In an embodiment, the memory controller 210 may generate a converted logic address by shifting the source logic address at least once by a number of bits set to the left or right, as the modified logic address. In an embodiment, the memory controller 210 may combine the converted logic address with the source logic address to generate the modified logic address. For example, the memory controller 210 may combine the converted logic address with the source logic address by at least one of an arithmetic summation, a logic summation, a logic multiplication, or the like.

The memory controller 210 may extract at least a portion of the modified logic address, such as a plurality of specified bit digit values, as a key value (at operation S209). In an embodiment, the memory controller 210 may extract a set N, where N is a natural number, of bits from the least significant bit LSB of the modified logic address as the key value KEY.

The memory controller 210 may set a physical address to an index including a fixed length generated by operating on the converted logic address and the key value as a set function, and generate mapping information by mapping the logic address related to the generated index and the physical address (at operation S211).

In an embodiment, the memory controller 210 may generate a hash value by operating on the modified logic address and the key value using a set hash function and determine an index based on the hash value, but is the embodiments are not limited to.

If not determined by the set workload (i.e., ‘N’ in operation S205), the memory controller 210 may extract at least a portion of the logic address, such as a plurality of specified bit values, as a key value (the operation S209).

The memory controller 210 may set a physical address to an index with a fixed-length generated by operating the logic address and a key value as a set function, and generate mapping information by mapping the logic address and physical address connected with the generated index (at operation S211).

When the external device 100 accesses a logic address of a stride pattern and a difference between the logic addresses included in each of the consecutive requests is constant, the indexes may be conflicted.

In this disclosure, the index may be generated with a key value extracted from the modified logic address by converting the source logic address at least once to avoid collisions between the indexes.

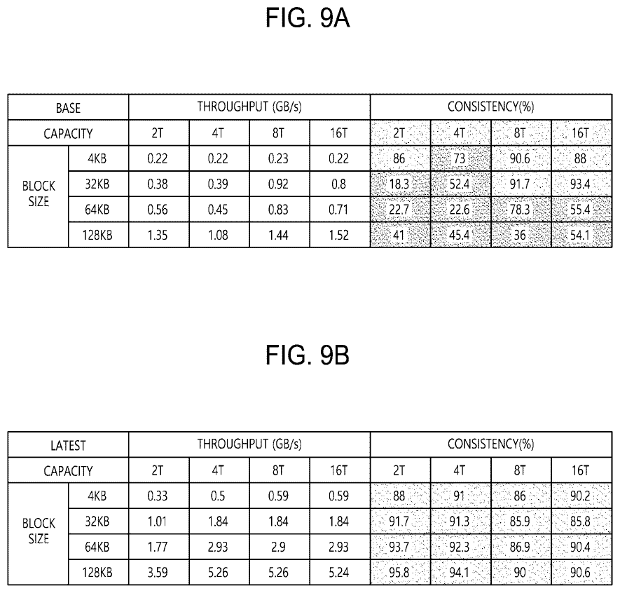

FIG. 9A and FIG. 9B are views illustrating a throughput and a performance consistency based on an address mapping scheme.

FIG. 9A shows the throughput and performance consistency when a stride patterned access request provided from an external device, based on a key value extracted from the source logic address, an index, and a physical address.

Referring to FIG. 9A, if the key value is extracted without converting or modifying the logic address of a stride pattern, the source logic addresses may be hashed with the same key value.

Therefore, the overhead of searching or generating the physical address corresponding to the source logic address makes it difficult to provide the required throughput. In addition, it can be noted that the throughput consistency may be inconsistent.

For example, when processing requests with a stride pattern for a 4 TB capacity memory device 4 T, it can be noted that the performance is very inconsistent compared to memory devices with other capacities 2 T, 8 T and 16 T.

FIG. 9B shows the throughput and consistency of a stride patterned access request from an external device when the source logic address is converted or modified to extract the key value and the key value and index are distributed.

Compared to FIG. 9A, it may be noted that overall processing performance has improved, including improved throughput and performance consistency for the 4 TB memory device 4 T.

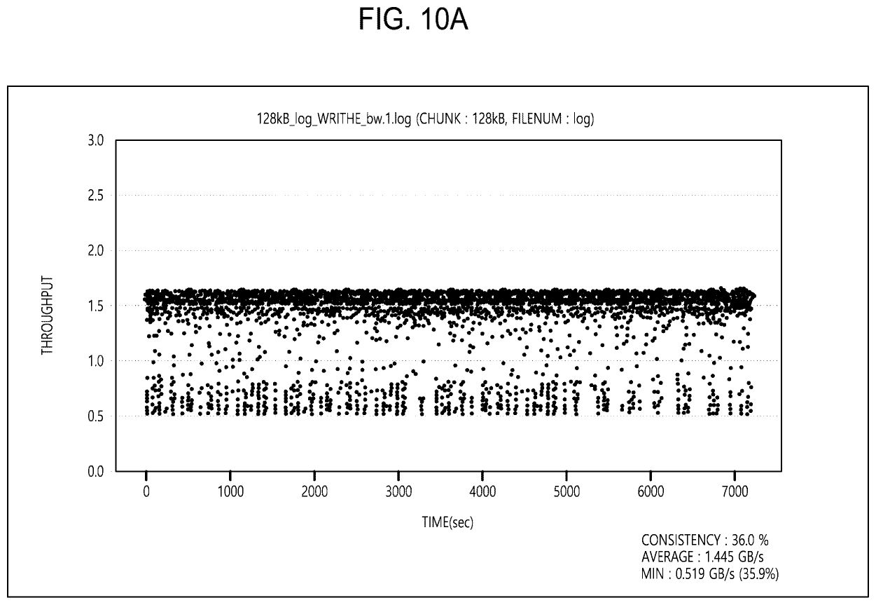

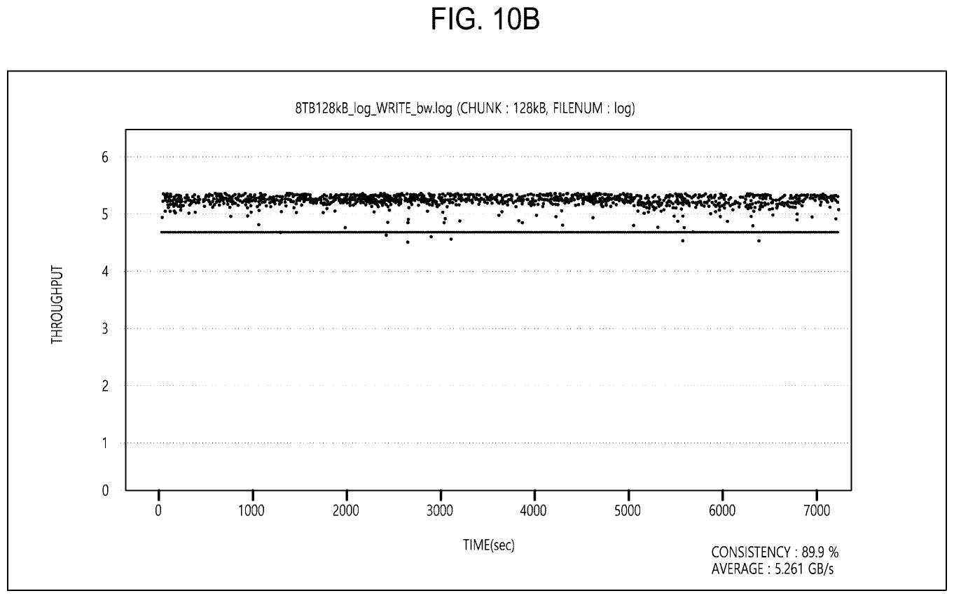

FIGS. 10A and 10B are views illustrating a difference in throughput based on the address mapping scheme.

FIG. 10A shows the throughput of an access request in a stride pattern for an 8 T capacity memory device with a block size of 128 KB when address mapping is performed without converting or refining the source logic address.

In FIG. 10A, a performance consistency is low at 36.0%, with an average throughput measured at 1.445 GB/s. It can be noted that the lowest throughput is 0.519 GB/s, which is 35.9% of the average throughput, indicating low performance consistency.

FIG. 10B shows the throughput when an address mapping is performed based on the key values generated by converting or modifying the source logic addresses for the access requests in the stride pattern to an 8 T capacity memory device with a block size of 128 KB.

In FIG. 10B, a performance consistency has improved to 89.9%, and the average throughput has improved to 5.261 GB/s.

As such, in workloads where the source logic address has a stride pattern, the source logic addresses may be converted or modified to generate the key values as described herein to improve throughput and performance consistency.

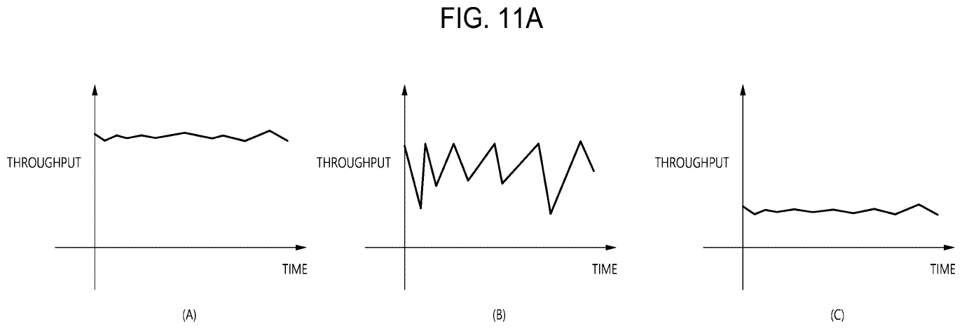

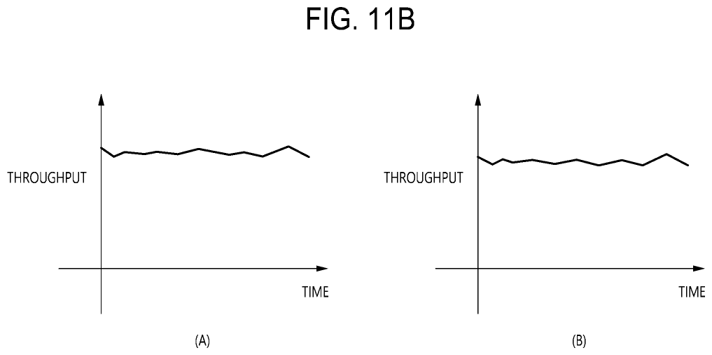

FIGS. 11A and 11B are views illustrating a difference in throughput based on workload and address mapping scheme.

FIG. 11A illustrates the throughput based on the address mapping scheme when processing sequential access patterns and stride access patterns where the logic addresses included in an access request are consecutive over a certain range or more.

Referring to FIG. 11A, when the logic addresses included in the continuous access pattern are used for address mapping without converting or modifying the logic address (see (A) of FIG. 11A), the consistency of the throughput was measured to be excellent.

On the other hand, if the logic addresses included in the stride patterns are address mapped without converting or modifying the logic address, it can be noted that throughput fluctuations are large over time (see (B) of FIG. 11A) or the throughput is measured low (see (C) of FIG. 11A).

FIG. 11B shows a throughput according to the address mapping scheme when processing sequential access patterns and stride access patterns.

Referring to FIG. 11B, when the logic addresses included in the continuous access pattern are used for address mapping without converting or modifying the logic addresses (see (A) of FIG. 11B), consistent high throughput may be observed.

If the logic addresses included in the stride pattern are address mapped after converting or modifying the logic addresses (see (B) of FIG. 11B), it can be noted that the throughput is measured to be high and consistent, similar to when dealing with sequential access patterns.

As such, in the workloads where the source logic addresses have a stride pattern, the source logic addresses may be converted or modified to generate the key values as described herein to ensure throughput and performance consistency similar to workloads with a sequential access pattern.

Those skilled in the art to which the invention described above belongs will understand that the invention may be practiced in other specific forms without altering its technical idea or essential features. It should therefore be understood that the embodiments of the present disclosure described above are illustrative in all respects and are not intended to be limiting. The scope of the present disclosure is indicated by the following claims rather than by the detailed description above, and all modifications or variations derived from the meaning and scope of the claims and their equivalents are to be construed as being within the scope of the present disclosure. Furthermore, the embodiments may be combined to form additional embodiments.

What is claimed is:

1. A data storage device comprising:
a memory device; and
a memory controller configured to extract a key value from a modified logic address generated by at least modification of a source logic address externally provided, and map, to a physical address of the memory device, an index generated based on the modified logic address and the key value.

2. The data storage device of claim 1, wherein the memory controller is configured to generate, as the modified logic address, a converted logic address by converting the source logic address at least once.

3. The data storage device of claim 2, wherein the memory controller is configured to generate the converted logic address by performing a shift operation on the source logic address.

4. The data storage device of claim 1, wherein the memory controller is configured to convert the source logic address at least once to generate a converted logic address, and combine the source logic address with the converted logic address to generate the modified logic address.

5. The data storage device of claim 4, wherein the memory controller is configured to generate the converted logic address by performing a shift operation on the source logic address.

6. The data storage device of claim 4, wherein the memory controller is configured to combine, by at least one of an arithmetic summation, a logic summation and a logic multiplication, the source logic address with the converted logic address to generate the modified logic address.

7. The data storage device of claim 1, wherein the memory controller is configured to generate the modified logic address when workloads of stride patterns with a uniform difference between adjacent source logic addresses are detected in requests of a same type, which are externally and continuously received.

8. The data storage device of claim 7, wherein, when the workloads of the stride patterns are not detected, the memory controller is configured to extract a first key value from the source logic address, and map a first index generated based on the source logic address and the first key value to a physical address of the memory device.

9. The data storage device of claim 1, wherein the memory controller is configured to generate the index by performing a hash function set based on the modified logic address and the key value.

10. A method of operating a data storage device including a memory device and a memory controller, the method comprising:
generating, by the memory controller, a modified logic address based on a source logic address externally provided;
extracting, by the memory controller, a key value based on the modified logic address;
generating, by the memory controller, an index based on the modified logic address and the key value; and
mapping, by the memory controller, the index to a physical address of the memory device.

11. The method of claim 10, wherein generating the modified logic address comprises converting the source logic address at least once.

12. The method of claim 11, wherein generating the modified logic address comprises performing a shift operation on the source logic address.

13. The method of claim 10, wherein generating the modified logic address comprises:
converting the source logic address at least once to generate a converted logic address; and
combining the source logic address with the converted logic address to generate the modified logic address.

14. The method of claim 13, wherein converting the source logic address comprises performing a shift operation of the source logic address.

15. The method of claim 13, wherein combining the source logic address comprises combining the source logic address and the converted logic address by at least one of an arithmetic sum, a logic summation and a logic multiplication.

16. The method of claim 10, wherein the modified logic address is generated when workloads of stride patterns with uniform differences between adjacent source logic addresses are detected in requests of a same type, which are externally and continuously received.

17. The method of claim 16, further comprising:
extracting, by memory controller, a first key value from the source logic address when the workloads of the stride patterns are not detected;
generating, by the memory controller, a first index based on the source logic address and the first key value; and
mapping, by the memory controller, the first index to a physical address of the memory device.

18. The method of claim 10, wherein generating the index comprises performing a hash function set based on the modified logic address and the key value.

19. A data storage device comprising:
a memory device; and
a memory controller configured to control the memory device,
wherein the memory controller comprises:
a mapping manager configured to generate an index based on a key value and a modified logic address, and generate mapping information by mapping the index and a physical address of the memory device, the key value being generated by extracting from the modified logic address generated by converting a source logic address externally provided at least once; and
a processor configured to control the memory device to program write data into a position of the memory device, corresponding to the mapping information in response to a write request externally provided;
wherein the key value extracted from specified bit digit values of the modified logic address, is generated with a random distribution, and
wherein the write data is distributed and stored in the memory device based on the key value with the random distribution.

20. A data storage device comprising:
a memory device; and
a memory controller configured to generate a physical address corresponding to a source logic address based on a key value extracted from a modified logic address generated from the source logic address included in a write request in response to the write request externally provided,
wherein, when the memory controller receives a stride patterned access request in which a difference between the source logic addresses included in continuously provided write requests is uniform, the key values extracted from the source logic addresses are identical, and the key values extracted from modified logic addresses generated based on the source logic addresses are different.
